(19) United States
(12) Patent Application Publication
(10) Pub. No.: US 2026/0311096 A1
(43) Pub. Date: Oct. 8, 2026

(54) Methods and Systems for Multi-System Selection for Evaluating Data to Obtain Strategic Objective and Resource Correlations

(71) Applicant: T-Mobile Innovations LLC, Overland Park, KS (US)

(72) Inventors: Robert BREWSTER, Spokane, WA (US); Brian HOLSCLAW, Seattle, WA (US); Sanjay Laxman KHARATE, Sammamish, WA (US); Michael A. KOVALCIK, Overland Park, KS (US)

(21) Appl. No.: 19/171,184

(22) Filed: Apr. 4, 2025

(51) Int. Cl. G06Q 10/0637

(52) U.S. Cl. CPC G06Q 10/0637

(57) ABSTRACT

A method comprising providing, in a communication network, a generative artificial intelligence system, a predictive model system, and a rule-based system, each programmed or trained based on strategic objectives of an enterprise and corresponding computing resources used to achieve the strategic objectives, receiving data from one or more data stores, selecting a system from the generative artificial intelligence system, the predictive model system, and the rule-based system to evaluate the data based on content of the data and a selection rule, and obtaining predicted output data using the selected system.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A business enterprise may maintain a wide range of data across different sectors of its organization. For example, the finance sector may generate spending records, budget forecasts, and capital investment plans, the operations sector may create system performance reports, outage/customer service logs, and infrastructure maintenance schedules, and the marketing and sales sector may create promotional materials, customer engagement strategies, and competitive analyses documents. Each of these data items may contain similar or different types of data but used for different purposes throughout the different sectors of the enterprise.

### SUMMARY

In an embodiment, a method for multi-system selection for evaluating data at an enterprise using a communication network is disclosed. The method comprises providing, in the communication network, a generative artificial intelligence system, a predictive model system, and a rule-based system, receiving, by an application executing at a data processing system in the communication network, raw data from one or more data sources in the communication network, performing, by the application, preprocessing on the raw data to obtain converted data, determining, by the application, a selected system to evaluate the converted data, determining, by the application, strategic objective data describing the strategic objectives associated with the enterprise based on the converted data being provided as input to the selected system, determining, by the application, resource data describing computing resources in the communication network and resource parameter data describing a use of the computing resources based on the converted data being provided as input to the selected system, and initiating, by the application, performance of an operation at the computing resources based on the resource parameter data. The generative artificial intelligence system evaluates data received in a prompt to determine strategic objectives of the enterprise and corresponding computing resources used to achieve the strategic objectives, wherein the predictive model system is trained using historical data indicative of the strategic objectives of the enterprise and the corresponding computing resources used to achieve the strategic objectives, and wherein the rule-based system is programmed with one or more system rules indicating conditions for correlating the strategic objectives with the corresponding computing resources. The selected system is selected from the generative artificial intelligence system, the predictive model system, or the rule-based system based on content of the converted data. The strategic objectives indicate priorities associated with the enterprise. The computing resources use the raw data to advance the strategic objectives, and the operation comprises stopping use of the computing resources to meet the strategic objectives.

In another embodiment, a data processing system comprising a non-transitory memory, a processor communicatively coupled to the memory, and an application stored at the memory is disclosed. The application, when executed by the processor, causes the processor to be configured to receive raw data from one or more data sources in a communication network, preprocessing the raw data to obtain converted data, select a system from a generative artificial intelligence system, a predictive model system, and a rule-based system to evaluate the raw data, determine the strategic objectives of the enterprise and the corresponding computing resources used to achieve the strategic objectives based on the converted data being provided as input to the system, and initiate performance of an operation at one of the corresponding computing resources based on resource parameter data describing a use of the one of the corresponding computing resources. The generative artificial intelligence system evaluates data received in a prompt to determine strategic objectives of an enterprise and corresponding computing resources used to achieve the strategic objectives, the predictive model system is trained using historical data indicative of prior strategic objectives of the enterprise and prior corresponding computing resources used to achieve the strategic objectives, and the rule-based system is programmed with one or more system rules indicating conditions for correlating the strategic objectives with the corresponding computing resources. The strategic objectives are priorities associated with the enterprise and the corresponding computing resources support advancement of the strategic objectives.

In yet another embodiment, a method is disclosed. The method comprises providing, in a communication network, a generative artificial intelligence system, a predictive model system, and a rule-based system, each programmed or trained based on strategic objectives of an enterprise and corresponding computing resources used to achieve the strategic objectives, and receiving, by an application executing at a data processing system in the communication network, data from one or more data stores. The method further comprises selecting, by the application, a system from the generative artificial intelligence system, the predictive model system, and the rule-based system to evaluate the data based on content of the data and a selection rule, and obtaining, by the application, predicted output data using the selected system, in which the predicted output data describes the strategic objectives and the corresponding computing resources indicated in the data and action data describing an operation to perform with respect to one or more of the corresponding computing resources.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network for multi-system selection and data evaluation for strategic objective and resource correlation according to an embodiment of the disclosure.

FIG. 2A is a diagram illustrating a generative artificial intelligence (AI) system in the communication network of FIG. 1 according to various embodiments of the disclosure.

FIG. 2B is a diagram illustrating a predictive model system in the communication network of FIG. 1 according to various embodiments of the disclosure.

FIG. 2C is a diagram illustrating a rule-based system in the communication network of FIG. 1 according to various embodiments of the disclosure.

FIG. 3 is a diagram illustrating the use of the systems from FIGS. 2A, 2B, and 2C in multi-system selection and data evaluation for strategic objective and resource correlation according to an embodiment of the disclosure.

FIG. 4 is a flowchart of a first method of multi-system selection and data evaluation for strategic objective and resource correlation according to an embodiment of the disclosure.

FIG. 5 is a flowchart of a second method of multi-system selection and data evaluation for strategic objective and resource correlation according to an embodiment of the disclosure.

FIG. 6 is a block diagram of a computer system implemented within the communication network of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

In the context of evaluating a business enterprise, a major technical challenge lies in correlating raw, unstructured data collected from various enterprise sectors with one or more strategic objectives of the enterprise. A strategic objective may refer to a defined enterprise goal reflected through identifiable patterns of activity, spending, or operational behaviors that drive specific information technology (IT) and/or business outcomes. For example, if the enterprise is a telecommunications service provider, the strategic objective may be to expand cellular coverage, automate customer support, reduce network latency, increase network security, etc. The difficulty arises when enterprise data is fragmented across different departments (e.g., finance, operations, engineering, marketing, etc.), and the fragmented data may be stored in different data formats, using different terminologies, across numerous data stores/platforms. For example, capital expenditure reports in the finance sector may describe high-level investment in “network modernization,” while infrastructure teams log work orders related to “fiber backhaul upgrades,” and procurement logs may reference vendor contracts for “optical transport hardware.” Technically, these data points describe related actions, but without common identifiers or standardized taxonomies across systems, there is no inherent link connecting the different terminologies to the same enterprise strategic objective.

Another technical challenge in this context is that much of the raw data is incomplete, noisy, or only partially descriptive of the underlying strategic intent, making it resource intensive to extract consistent signals across heterogenous datasets. Further, once potential strategic objectives are identified, a significant technical hurdle remains in tracing how those objectives translate into specific computing infrastructure and platforms within the network. For instance, identifying that a strategic objective involves reducing customer churn through improved service reliability may involve pinpointing which computing resources (e.g., network elements—such as edge servers, base stations, or customer premises equipment, platforms, etc.) are involved in processing the data in an attempt to advance the objective of reducing customer churn. This process may involve identifying the specific data items that flow through the identified computing resources to advance the objective of reducing customer churn. This correlation is challenging and largely inefficient to identify computationally because operational systems are often siloed, and the data collected at the network level lacks explicit references back to enterprise-level strategic objectives and projects.

Moreover, determining where data is used across the network itself introduces further technical complexity. Business-sector data like strategy documents or budget plans exist at the application layer and may reside in isolated platforms such as internal documentation systems, ticketing systems, or financial databases. These systems may not be directly integrated with real-time network telemetry, meaning that even if the enterprise aims to optimize network performance in pursuit of a strategic objective, the operational data generated at the network layer (e.g., packet loss statistics, handover failure rates) may not easily be mapped back to the higher-level business sector data. Without purpose-built data models and automated linking mechanisms that connect business-level datasets with physical or virtual network resources, it becomes difficult and inefficient to measure the effectiveness of strategic objectives in practice, and to identify how resources deployed across the network are contributing to or hindering the enterprise's strategic objectives.

The present disclosure addresses the foregoing technical problems by providing a technical solution in the technical field of enterprise data analysis and network resource correlation. The embodiments disclosed herein include systems and methods for identifying strategic objectives from multi-domain enterprise data and mapping the strategic objectives to operational computing resources (e.g., infrastructure and platforms) within a communications network. In some embodiments, a data processing system may obtain raw enterprise data from various data stores, perform preprocessing on the raw enterprise data to obtain converted data, and select an optimal system (from a local application implementing statistical methods, a generative artificial intelligence (AI) system, a predictive model system, a rule-based system, etc.) to evaluate the converted data and determine the strategic objectives and corresponding computing resources that are used to support the strategic objectives. The selected system may also detect an operation or action to take with respect to the computing resources that may further advance an objective.

The disclosed solution solves the aforementioned technical problems by implementing automatic data processing techniques that normalize, categorize, and semantically align disparate data sources originating from multiple sectors of an enterprise. The selected optimal system may apply a contextual evaluation to detect related concepts across different types of raw data (unstructured and structured data) to infer strategic objectives even when the underlying data lacks explicit linkage. In addition, the selected optimal system may integrate business-sector data with operational network data, enabling identification of specific computing resources, platforms, and network elements contributing to the objectives. By establishing these correlations using an optimally selected system, end-to-end visibility into how an enterprise objective may drive network operations may be provided to implements a technical framework for measuring and optimizing resource allocation in support of the objectives.

The embodiments disclosed herein may be performed in a communication network may include a data processing system, one or more data stores, one or more computing resources, a generative artificial intelligence (AI) system, a predictive model system, and a rule-based system, all interconnected by a network. A generative AI system is an AI-based system that uses machine learned patterns from large datasets to generate new content—such as text, code, data structures, images, etc.—in response to input prompts, in which the new content is contextually relevant to the provided prompt. For example, the generative AI system may use a large language model (LLM) that is pretrained using unsupervised or semi-supervised learning on large corpora of textual data, such as publicly-available corporate filings, internal documentation, technical reports, and industry literature. The generative AI system may process the prompt using the pretrained model to identify semantic patterns, relationships, and context from the input data to generate output that reflects inferred insights or synthesized content aligned with the objectives or requests indicated in the prompt.

The predictive model system may refer to a machine learning model system that is trained on labeled, domain-specific historical data to perform a defined predictive task, such as classification, regression, or clustering. Unlike generative AI systems, which generalize from broad, open-ended training data, the predictive model system for enterprise data evaluation may be trained with supervised learning techniques, using enterprise-specific historical datasets with examples that are tagged according to desired outputs—such as identifying strategic objectives and corresponding computing resources, identifying paths to modify the use of the computing resources to accomplish the strategic objectives, etc. Feature engineering may be applied to extract structured attributes from the raw data (such as document metadata, key phrases, or numerical fields), and these features may be fed into machine learning algorithms at the predictive model system.

The rule-based system may be a deterministic, logic-driven system that evaluates data by applying predefined rules created manually by domain experts. These rules may follow “if-then” logic structures, where specific patterns, keywords, thresholds, or conditions within the data trigger defined classifications, actions, or outputs. For example, a rule-based system might classify a document as relating to network infrastructure if it contains phrases like “fiber deployment” and “core network upgrade” within a financial quarter's capital expenditure report.

The data processing system may include an application that communicates with the one or more data stores to obtain raw data, perform preprocessing on the raw data to obtain converted data, and determine whether to evaluate the converted data using a local statistical application or to input the data into a selected one of the generative AI system, predictive model system, or rule-based system, to output various predictions. The local statistical application may be programmed to perform various statistical methods on the converted data to obtain predicted output data (e.g., strategic objective data and corresponding computing resource data identifying the computing resources used to accomplish the objectives). The various statistical methods may include, for example, a Term Frequency-Inverse Document Frequency (TF-IDF) method that may evaluate the importance of a word within the converted data (e.g., specific document) relative to a larger collection of documents, and may assign a higher score to words that appear frequently in the document, helping identify terms that are particularly relevant or distinctive within the context of the converted data. The TF-IDF scores may allow the statistical application to detect common keywords, categorize documents by topic, or measure similarity between different data items in the converted data based on shared high-weighted terms. By comparing these scores across a converted data, the statistical application can correlate related documents, surface relevant information, and group data according to recurring business concepts or strategic objectives, supporting a targeted analysis without requiring complex model training.

The data stores may store raw data that may be used by various sectors of the enterprise, and the raw data may directly or inherently indicate linkages between strategic objectives of the enterprise. The raw data stored across the data stores may be the original unprocessed outputs of disparate enterprise sectors. For example, the raw data may include financial documents, press releases, prior operation histories, internal strategy documents, proposal documents, spending records, proposal documents, customer support logs, internal memos, service outage reports, partnership announcements, regulatory filings, social media activity, analyst reports, etc. The raw data may be vast, inconsistent, and highly unstructured, creating significant challenges in processing and extracting meaningful insights. The raw data may be generated independently across different enterprise sectors (e.g., finance, operations, engineering, sales, compliance, etc.) without inherent coordination or shared structure, resulting in fragmented and sometimes redundant representations of redundant families. Therefore, the raw data is not only heterogenous in format (e.g., PDFs, CSV files, emails, SQL databases, etc.), but also may have numerous semantic inconsistencies.

The application at the data processing system may obtain the raw data from the one or more data stores and perform preprocessing on the raw data to obtain converted data, which may be evaluated much more efficiently and effectively to identify strategic objectives and corresponding computing resources or platforms that use the raw data to support the strategic objectives. To preprocess the raw data and obtain converted data, the application may apply a normalization pipeline that converts heterogenous data formats of the raw data into converted data having unified, readable structures. For instance, the application may perform deduplication and/or version control to eliminate redundant or outdated records (to ensure only that the most relevant and current data is processed); the application may perform natural language processing (NLP) techniques to clean the text, standardize the terminology, and correct inconsistences in naming conventions across enterprise sectors and may apply entity extraction algorithms to identify key references to technologies while aligning events and records to support chronological correlation; and the application may also perform categorization to assign the raw data to predefined categories (e.g., capital expenditures, service performance, infrastructure deployment, customer experience, etc.), such that the corresponding converted data may also be applied to the same predefined categories. The application may perform one or more of the aforementioned preprocessing operations on the raw data to obtain converted data, which may be used by the application or an optimally selected system to perform semantic alignment to link conceptually related converted data across different sectors.

Once the converted data is generated, the application may evaluate the converted data according to one or more selection rules (e.g., stored at the data processing system) to determine whether the local statistical application should perform statistical methods on the converted data to output predicted data, or to determine which model/system (between the generative AI system, the predictive model, or the rule-based system) to use when processing the converted data for strategic objective and platform determination. A selection rule may include logic or code defining certain conditions associated with a context of a data evaluation request or the content of the converted data, that when met, may instruct the application to input the converted data to the local statistical application or to either the generative AI system, the predictive model system, or the rule-based system. For example, a selection rule may indicate that when there is a need to evaluate the converted data most efficiently using a local, more secure method of data evaluation, the local statistical application executing at the data processing system may be used (instead of the generative AI system, the predictive model system, or the rule-based system).

A selection rule may include logic or code defining the conditions associated with the content of the converted data, that when met, may instruct the application to select an optimal system from the generative AI system, the predictive model system, or the rule-based system to evaluate the converted data. For example, the preprocessing step may have grouped certain items of the converted data into one or more predefined categories. One or more selection rules may indicate that data of a predefined category is recommended to be provided as input to a selected system of the generative AI system, the predictive model system, or the rule-based system. The selection rules may be based on predefined optimizations between types of input data (e.g., converted data) and the accuracy/reliability of the output data of the selected system. In this way, the application may use selection rules to select an optimal system to use to predict strategic objectives and corresponding computing resources based on the converted data.

The selection rules may also be based on the inherent characteristics or attributes of each of the generative AI system, the predictive model system, and the rule-based system. For example, generative AI systems may be particularly beneficial for handling noisy, incomplete, or unstructured datasets, since generative AI systems can infer context and fill informational gaps that standard machine learning models might discard as unusable. However, generative AI systems operate probabilistically and may sometimes generate outputs that, while coherent, are not strictly verifiable, making them better suited for exploratory analysis rather than deterministic decision-making. Meanwhile, the key benefit of the predictive model system (or more specifically, the machine learning models employed at the predictive model system) may be in the ability to produce more accurate, task-specific predictions with explainable outputs and consistent behavior, assuming sufficient high-quality training data exists. However, the predictive model system may have to be retrained periodically when applied to new or evolving categories/types of raw data. The rule-based system may excel in environments where the decision criteria are well-understood, repeatable, and may involve high precision, as the rules execute substantially identically given the same inputs and provide traceability of why a decision was made. The limitations in the rule-based system may arise from the inflexibility of the system, since the rules cannot be easily adapted to new languages, unexpected patterns, or evolving enterprise terminology without manual updates and rule maintenance. Therefore, the selection rules may also consider organizational goals/needs, regulations, and other contextual factors that may affect whether the converted data is to be input the into the generative AI system, predictive model system, or the rule-based system, based on the strengths and limitations of each.

In some cases, the three systems may be synergized to work together to combine the strengths of each of the three systems, and the selection rules may include conditions that focus on the individual strengths of the system, to perform various operations with respect to the strategic objectives and the computing resources. For example, the generative AI system may be capable of identifying hidden gaps by suggesting emerging platforms and trends (though the recommendations may lack structured validation). Meanwhile, the predictive model system may fill this gap by grounding computing resource/platform selection in historical success rates, reliability, and adoption trends, ensuring data-backed decisions. The rule-based system may provide more strict, predefined mappings for consistency, but may miss exceptions where prior performance deviates from the system rules. For example, one selection rule may involve splitting up various tasks across the three different systems: instruct the generative AI system to suggest options, instruct the predictive model system to validate the options with historical patterns, and instruct the rule-based system to enforce business logic. This synergistic process may ensure adaptive system selection while maintaining compliance, explain ability, and alignment with organizational strategy.

Regardless of the selected system (either the generative AI system, predictive model system, or the rule-based system), each selected system may be programmed to generate predicted output data based on the converted data input into the selected system (e.g., either using the machine learning model algorithms at the generative AI system and the predictive model system, or the rule-based programming at the rule-based system). The predicted output data may include at least one of the strategic objectives determined based on the converted data, the computing resources (e.g., platforms, network elements, etc.) that use the raw data to perform tasks/operations to support/make progress toward the strategic objectives, mappings that define an association between the identified strategic objectives and the computing resources that are used to support the respective strategic objective, resource parameter data describing a usage or capacity at each of the identified resources, and/or any other trends that may be identified based on the converted data input into the system.

The predicted output data may also include data describing actions or operations that may be performed across one or more of the computing resources implementing a given strategic objective. The predicted operation may be determined based on at least one of the trend data observed in the converted data, objective-to-resource mappings defining an association between each computing resource and a strategic objective, and the resource parameter data describing a usage or capacity at each of the identified resources. For example, the objective-to-resource mappings may be processed to evaluate if some computing resources are underutilized, and if so, the operation may be to reallocate underutilized resources. On the other hand, if the trend data for a particular resource indicates that resource may be overutilized in the near future, and that the resource may run out of capacity within a predefined period of time in the future, then the predicted operation may be to scale up use of the resource by, for example, increasing capital spending to increase resources for that strategic objective.

In some cases, certain strategic objectives may be more important than others, and may have a higher priority than others. In this case, certain strategic objectives may be assigned weights based on the priority or importance of the strategic objectives. The operations related to the higher priority strategic objectives may be performed before operations related to lower priority strategic objectives. This weighting may figure into the allocation of resources and figure into the capital spending plans of the enterprise. The application at the data processing system may initiate performance or automate performance of the predicted operation across the computing resources as instructed.

In this way, the data processing system may strategically use a local statistical application and/or an optimal type of system (e.g., the generative AI system, predictive model system, or rule-based system) to evaluate enterprise-related data stored across disparate data sources in different formats and using different terminologies. The data processing system may also perform robust preprocessing on the raw data to reduce the amount of data fed to the different systems for training and rule-based programming, ensuring that the most relevant, normalized, easy-to-evaluate data is sent to the systems for training and programming. By preprocessing the data and using the optimal system to perform data evaluation with respect to enterprise strategic objectives and platform correlations, the ultimate use of the data may be monitored and controlled across all the computing resources in an intelligent and strategic manner. For example, data redundancies and failures/latencies across the computing resources can be prevented, which may ultimately translate to increased network capacity and efficiencies at the communication network. Moreover, the embodiments disclosed herein facilitate completion of the strategic objectives on high-level and at the network resource level.

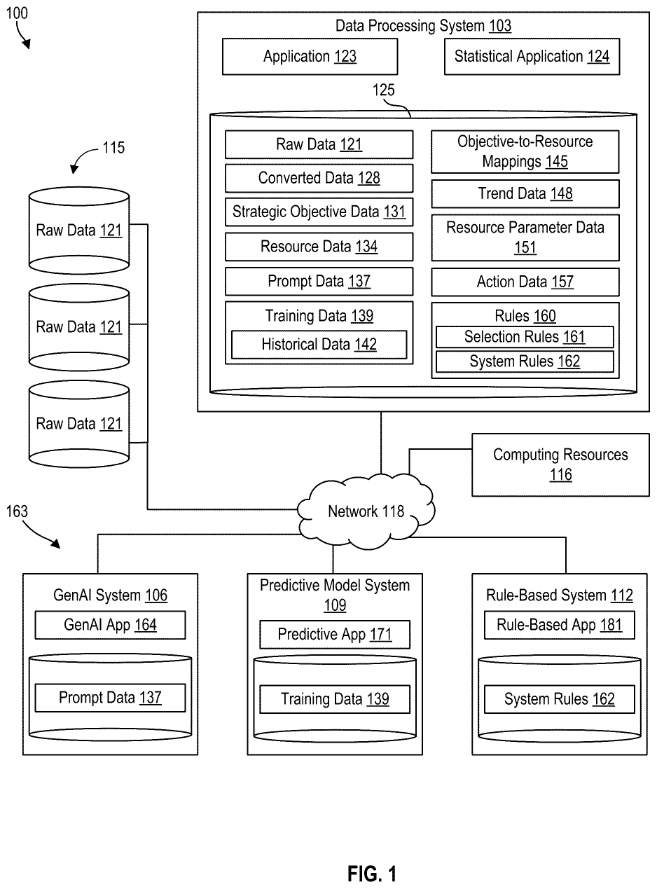

Turning now to FIG. 1, a communication network 100 is described. The communication network 100 includes a data processing system 103, a generative AI system 106 (shown in FIG. 1 as a “genAI system 106”), a predictive model system 109, a rule-based system 112, one or more data stores 115, computing resources 116, and a network 118. The network 118 may be one or more private networks, one or more public networks, or a combination thereof. While the data processing system 103, generative AI system 106, predictive model system 109, rule-based system 112, data stores 115, and computing resources 116, are shown as separate from the network 118 in FIG. 1, it should be appreciated that the data processing system 103, generative AI system 106, predictive model system 109, rule-based system 112, data stores 115, and computing resources 116 may be included as part of the network 118 in various embodiments. While the data processing system 103, generative AI system 106, predictive model system 109, rule-based system 112, data stores 115, and computing resources 116 are all shown as separate in FIG. 1, in some embodiments, one or more of the data processing system 103, generative AI system 106, predictive model system 109, rule-based system 112, data stores 115, and computing resources 116 may be hosted or located together. In an embodiment, various enterprises may use the services provided by the data processing system 103 in conjunction with the generative AI system 106, predictive model system 109, and rule-based system 112.

The one or more data stores 115 may include different memories (e.g., co-located or distributed) that are accessible by the data processing system 103. The data stores 115 may store raw data 121 (e.g., structured or unstructured data) created and used by various sectors of an enterprise, and the raw data may 121 directly or inherently indicate linkages between strategic objectives of the enterprise. The raw data 121 stored across the data stores 115 may be the original unprocessed outputs of disparate enterprise sectors. For example, the raw data 121 may include financial documents, press releases, prior operation history, internal strategy document, proposal documents, spending records, proposal documents, customer support logs, internal memos, service outage reports, partnership announcements, regulatory filings, social media activity, analyst reports, etc., associated with one enterprise or multiple different enterprises. The raw data 121 may be generated independently across different enterprise sectors (e.g., finance, operations, engineering, sales, compliance, etc.) without inherent coordination or shared structure.

The data processing system 103 may be a system (e.g., a set of servers including a collection of memory, processing, and communication resources) responsible for performing multi-system selection for evaluating data to obtain strategic objective and computing resource correlations. The data processing system 103 may include an application 123 and a statistical application 124. The application 123 may execute at the data processing system 103 and may receive relevant raw data 121 from the data stores 115, perform preprocessing on the raw data 121, train the predictive model system 109 and/or program the rule-based system 112, select an optimal system from the generative AI system 106, predictive model system 109, or rule-based system 112 to evaluate the data, evaluate the data with the optimally selected system, and perform an operation on computing resources based on the evaluation of the data, as further described herein.

The statistical application 124 may be programmed to perform various statistical methods on converted data to obtain predicted output data (e.g., strategic objective data and corresponding computing resource data identifying the computing resources used to accomplish the objectives). The various statistical methods may include, for example, a TF-IDF method that may evaluate the importance of a word within the converted data (e.g., specific document) relative to a larger collection of documents, and may assign a higher score to words that appear frequently in the document, helping identify terms that are particularly relevant or distinctive within the context of the converted data. The TF-IDF scores may allow the statistical application 124 to detect common keywords, categorize documents by topic, or measure similarity between different data items in the converted data based on shared high-weighted terms. By comparing these scores across a converted data, the statistical application 124 may correlate related documents, surface relevant information, and group data according to recurring business concepts or strategic objectives, supporting a targeted analysis without requiring complex model training.

The data processing system 103 may include a data store 125 (e.g., one or more memories) storing data used and created by the application 123 and/or the statistical application 124 to perform the aforementioned operations. The data store 125 stores raw data 121, converted data 128, strategic objective data 131, resource data 134, prompt data 137, training data 139, objective-to-resource mappings 145, trend data 148, resource parameter data 151, action data 157, and rules 160. The raw data 121 may be received from the data stores 115 and stored at the data store 125. The converted data 128 may refer to the converted or transformed version of the raw data 121 after the application 123 has performed preprocessing on the raw data 121. The strategic objective data 131 may refer data describing one or more strategic objectives. A strategic objective may refer to a defined enterprise goal or priority reflected through identifiable patterns of actions, investments, or operations aimed at achieving specific outcomes, such as improving network performance, expanding service offerings, improving infrastructure security, etc. The strategic objective data 131 may include a value (e.g., text, codes, identifiers) identifying the strategic objective and describing a context of the strategic objective (e.g., an associated timeframe, relevant business units, related projects, or operational focus).

The resource data 134 may refer to the computing resources 116 that use the raw data 121 to support one or more strategic objectives. A computing resource 116 may “support” a strategic objective when the computing resource 116 executes, processes, stores, or facilitates data, applications, or workloads that directly or indirectly contribute to the performance of operations or services aligned with achieving the strategic objective. To this end, the computing resources 116 may refer to hardware, software, and/or cloud-based systems that provide the processing power, storage, networking, and application execution necessary to support the implementation of strategic objectives using the raw data 121. The computing resources 116 may enable the collection, processing, analysis, and delivery of data-driven insights and operational actions across the enterprise. Examples of computing resources 116 may include cloud platforms (e.g., virtual machines, container orchestration systems, etc.), database systems (e.g., relational databases, data lakes), data processing frameworks, network infrastructure (e.g., computing nodes, core routers, etc.), etc., that collectively manage and execute workflows aligned with strategic objectives. To this end, the resource data 134 may refer to information generated by, associated with, or describing the operation, configuration, performance, or utilization of the computing resources 116 (e.g., including system logs, resource identifiers, workload metrics, deployment records, etc.—that may indicate how the computing resources 116 support specific strategy objectives).

The objective-to-resource mappings 145 may include data associating a strategic objective (as identified in the strategic objective data 131) with the corresponding computing resources 116 (as identified in the resource data 134) that are used to support the strategic objective. For example, the objective-to-resource mappings 145 may include mappings between an identifier of a strategic objective and identifiers or addresses of the corresponding computing resources 116 that are processing workloads in an attempt to advance the strategic objective. The resource parameter data 151 may include data describing used or available resources at each of the computing resources 116. The resource parameter data 151 may include data describing operational characteristics of each computing resource 116, including usage metrics (e.g., processing load, memory consumption, network throughput), capacity metrics (e.g., maximum supported workloads, storage limits), and other related parameters that reflect the computing resource 116 performance and availability. In some cases, the resource parameter data 151 may also be tracked or segmented per strategic objective to indicate how much of the usage or capacity at a computing resource 116 is allocated to supporting specific enterprise goals.

The trend data 148 may include data representing changes or patterns detected in the converted data 128 over time, used to identify historical strategic objectives, performance shifts, or evolving conditions within enterprise conditions. The trend data 148 may include time-based observations of resource usage, capacity fluctuations, project spending, or operational outcomes. The prompt data 137 may include a historical record of prompts provided to the generative AI system 106, in which each prompt may include raw data 121 and other contextual information relating to, for example, the global context or enterprise strategy, a business theme or specific function, and/or a task-specific objective. The prompt may thus ensure that the output data predicted by the generative AI system 106 aligns with the business goals, regulations, and operational needs of the enterprise. The prompt data 137 may also indicate an accuracy or performance metric for each prompt, indicating whether the generative AI system 106 produced an accurate, relevant, and intended result. The prompt data 137 may enable evaluation and refinement of prompt strategies over time.

The action data 157 refers to data describing operations or tasks that are instructed to be executed on the computing resources 116 based on analysis of the raw data 121, converted data 128, strategic objective data 131, objective-to-resource mappings 145, resource parameter data 151, trend data 148, and/or prompt data 137. For example, the action data 157 may include instructions for the application 123 to perform specific actions, such as, adjusting resource allocations, initiating workflows, deploying services, or modifying configurations across one or more of the computing resources 116. The action data 157 may include data describing the target computing resource(s) 116, the parameters of the action, and the strategic objective the action is intended to support.

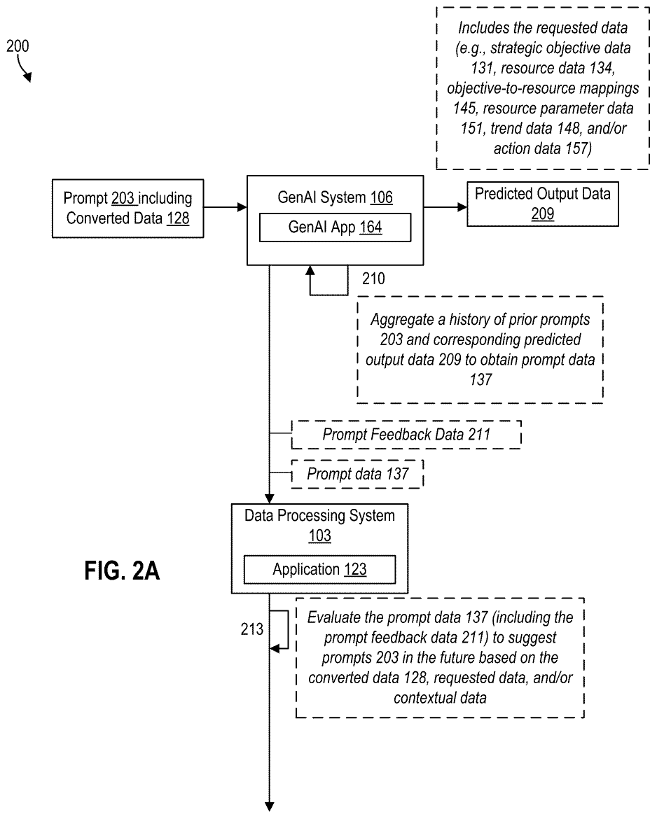

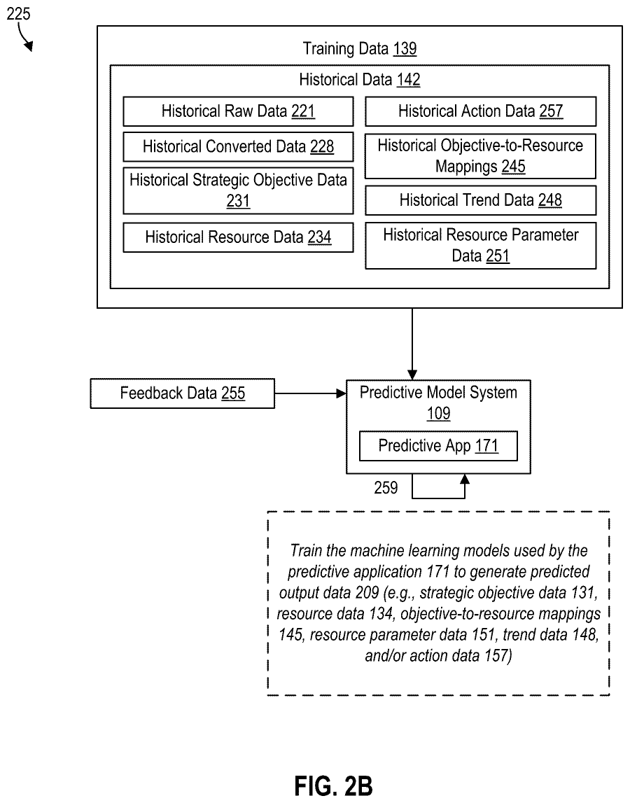

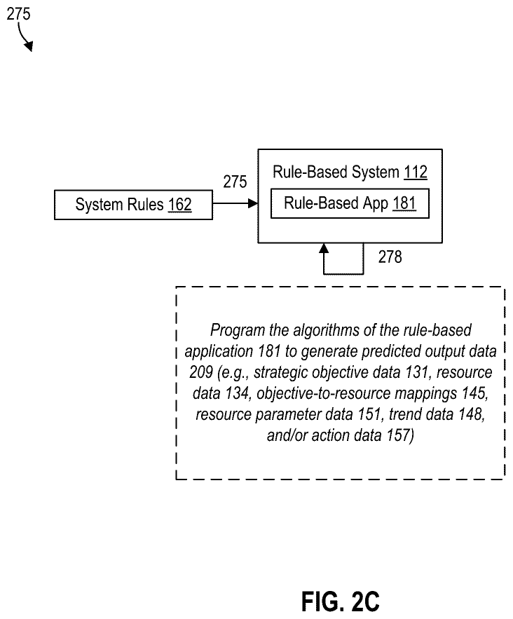

The training data 139 may refer to the historical data 142 that is collected over an extended period of time (e.g., several months or years) from one or more of the raw data 121, converted data 128, strategic objective data 131, objective-to-resource mappings 145, resource parameter data 151, trend data 148, prompt data 137, and/or action data 157. The historical data 142 may be used to train the generative AI system 106 and/or the predictive model system 109, as further described below with reference to FIG. 2B.

The rules 160 may include selection rules 161 used by the application 123 to govern the selection of an optimal system 163 (from the generative AI system 106, predictive model system 109, and/or rule-based system 112), and system rules 162 that may be sent to the rule-based system 112. The selection rules 161 may include logic or code defining conditions associated with the converted data 128 that, when met or satisfied, instructs the application 123 to send the converted data 128 to either the statistical application 124 for local processing or an optimal system 163 (again, selected from the generative AI system 106, predictive model system 109, and/or rule-based system 112). For example, one or more selection rules 161 may indicate that data of a predefined category is to be instructed to be provided to either the generative AI system 106, the predictive model system 109, or the rule-based system 112 as the optimal system 163 when the converted data 128, requested output data, or context of the request meets certain predefined conditions. The selection rules 161 may be based on predefined optimizations between types of input data (e.g., converted data 128) and the accuracy/reliability of the output data of the selected system 163. The selection rules 161 may also be based on the inherent characteristics or attributes of each of the generative AI system 106, the predictive model system 109, and the rule-based system 112, as described above. The selection rules 161 may also consider organizational goals/needs, regulations, and other contextual factors that may affect whether the converted data 128 is to be evaluated locally using the statistical application 124 or input the into the generative AI system 106, predictive model system 109, or the rule-based system 112, based on the strengths and limitations of each.

The system rules 162 may be predefined by an operator based on an evaluation of historical relationships or trends between types of converted data 128 and the corresponding strategic objective, computing resources 116, etc. The system rules 162 may be predefined rules, including predefined logic or code statements, based on one or more conditions associated with (e.g., the characteristics or attributes of) the converted data 128. When the conditions associated with the converted data 128 are met or satisfied, a rule-based application 181 at the rule-based system 112 may be triggered to evaluate the converted data 128 to output requested/predicted data (e.g., to output the strategic objective data 131, resource data 134, objective-to-resource mappings 145, resource parameter data 151, trend data 148, and/or action data 157). Each system rule 162 may define conditions or patterns, such as, for example, the presence of certain keywords, numerical thresholds, or data relationships, that when satisfied by the input converted data 128, may trigger corresponding actions, decisions, or labels that support the identification of the strategic objective data 131, resource data 134, objective-to-resource mappings 145, resource parameter data 151, trend data 148, and/or action data 157.

The generative AI system 106 refers to a set of computing resources (hardware and software) implementing a machine learning-based system. The generative AI system 106 may be designed to generate new data outputs—such as text, code, or other content—based on patterns learned from large-scale training datasets. The generative AI system 106 may include advanced neural network architectures, such as transformer models, which may be trained using unsupervised or semi-supervised learning techniques on massive corpora of unstructured data to learn statistical relationships between tokens, words, or symbols. During training, the model may adjust internal parameters to minimize prediction errors, enabling the model to produce contextually relevant outputs in response to diverse inputs. The generative AI system 106 may encompass underlying machine learning models and may generate coherent, novel content rather than merely classify or predict fixed labels. The generative AI system 106 may receive prompts, converted data 128, and other contextual data (e.g., artifact files in various formats that have undergone the preprocessing steps disclosed herein) as input data, and may output text, images, or other content describing, for example, the identification of the strategic objective data 131, resource data 134, objective-to-resource mappings 145, resource parameter data 151, trend data 148, action data 157, other types of recommendations, synergy opportunities across the different systems 106, 109, and 112, gap analysis, etc. The generative AI system 106 may be secure and well-governed, with all data being encrypted and secure.

The generative AI system 106 may include a generative AI application 164 (shown in FIG. 1 as “genAI app 164”) that may control the weights, parameters, algorithms, and other attributes of the machine learning models to receive a prompt, converted data 128, requested data, and other contextual data from the application 123, run the algorithms based on the input data received with the prompt, and output predicted data. The output predicted data may include the strategic objective data 131, resource data 134, objective-to-resource mappings 145, resource parameter data 151, trend data 148, and/or action data 157. The generative AI system 106 may also store the prompt data 169 based on historical prompts received at the generative AI system 106.

The predictive model system 109 may refer to a set of computing resources (hardware and software) also implementing a machine learning-based system. The predictive model system 109 may be configured to analyze input converted data 128 to generate specific predictions, classifications, or recommendations based on patterns learned from historical, labeled training data 139. The predictive model system 109 may utilize supervised learning algorithms, such as decision trees, support vector machines, or neural networks, which are trained using datasets containing known inputs and corresponding outputs to optimize the model's ability to generalize to new, unseen data. Unlike the generative AI system 106 that produce free-form outputs, predictive model system 109 may be designed to output structured results, such as identifying whether a document relates to a particular strategic objective or forecasting computing resource 116 usage levels. The predictive model system 109 may continuously evaluate feature sets derived from the input converted data 128 to produce highly accurate predicted data (e.g., including the strategic objective data 131, resource data 134, objective-to-resource mappings 145, resource parameter data 151, trend data 148, and/or action data 157).

For example, the predictive model system 109 may implement a multi-label logistic regression model that predicts computing resources 116 for a given strategic objective, and may inform additional insights such as whether the computing resources 116 are leveraged or modified. The predictive model system 109 may also implement a wide variety of AI models, for example, including, but are not limited to, machine learning models, deep learning models, large-language models (LLMs), and retrieval-augmentation gerneration (RAG)-based models (that incorporate external knowledge databases into LLMs). The predictive model system 109 may use historical initiative data, text descriptions, and structured business metrics, with NLP embeddings and structured data to predict platform selection (e.g., whether they should be leveraged or modified, considering cost, timeline, and business impact). The predictive model system 109 extracts business capabilities from initiative descriptions, aligns them with historical platform trends, and integrates success rates, complexity, and reliability for data-driven decisions. The predictive model system 109 may be trained using a supervised learning approach on structured enterprise data (e.g., raw data 121 that has been preprocessed into converted data 128), including textual data (NLP embeddings) (e.g., initiative descriptions with embedded business capabilities (AI, ERP, CRM), structured features (e.g., cost, time, business value, success rate, complexity score, past delays as an example), historical platform usage (e.g., identifies platforms/computing resources 116 used in past initiatives), and leverage versus modification labels (e.g., tracks how platforms were used or modified).

The predictive model system 109 may include a predictive application 171 that may control the weights, parameters, algorithms, and other attributes of the machine learning models to run the algorithms using the input data, and output predicted data. The input data may include, for example, the converted data 128, requested data, and any other contextual data (e.g., including text data (NLP embeddings from which business capabilities may be extracted from the text and/or structured numeric data including cost, time, business value, platform reliability rates, adoption rates, initiative complexities, delivery delays, and platform feasibility). The predictive model system 109 may be trained using the training data 139, which as described above includes historical data 142 collected over an extended period of time. The predictive model system 109, once trained, may automatically link converted data 128 to the strategic objective data 131, resource data 134, objective-to-resource mappings 145, resource parameter data 151, trend data 148, and/or action data 157 (which may ultimately measure the effectiveness of strategic objectives in practice, and to identify how the computing resources 116 deployed across the communication network 100 are contributing to or hindering the enterprise's strategic objectives).

The rule-based system 112 may refer to a set of computing resources (hardware and software), programmed based on the system rules 162. For example, the application 123 may gather and transmit the system rules 162 to the rule-based system 112, and the rule-based system 112 may automatically self-program or configure itself to perform/execute based on the system rules 162. To this end, the rule-based system 112 may include a rule-based application 181 that may be programmed based on the system rules 162.

In this way, the rule-based system 112 may be a deterministic computing system configured to evaluate input converted data 128 using a predefined set of system rules 162, where each system rule 162 specifies conditions or patterns within the converted data 128 that, when matched, may indicate specific outputs, classifications, or actions. The system rules 162 may be expert-defined logic statements (e.g., if-then rules) that operate on attributes, values, or relationships found in the converted data 128. The rule-based system 112 may include a rule-based application 181, which may be programmed to operate on the received input data based on the system rules 162. Unlike machine learning models, rule-based systems 112 may not require training on historical datasets and instead rely on explicit, static system rules 162 that may be manually created and maintained as data patterns evolve.

Referring now to FIGS. 2A, 2B, and 2C shown are diagrams illustrating the training and programming of the generative AI system 106, the predictive model system 109, and the rule-based system 112.

Turning specifically now to FIG. 2A, shown is a diagram 200 illustrating the use of the generative AI system 106 to generate prompt data 137 and transmit the prompt data 137 back to the data processing system 103. As mentioned above, the generative AI system 106 may be pretrained based on large, general-purpose datasets by third-party providers. These pretrained models—like large language models (LLMs)—come with billions of parameters already optimized to understand and generate human-like text based on broad language patterns. Said another way, additional training may not be needed for the models used by the generative AI system 106 since generative AI models may capture general language understanding such that enterprises may adapt generative AI models with techniques such as fine-tuning or prompt engineering to align with specific domains without retraining the full model.

To this end, the generative AI system 106 may aggregate and collect a history of prompts 203 that have been provided as input into the generative AI system 106 with or without converted data 128 (generated by the application 123 at the data processing system 103 by performing preprocessing on raw data 121). First, a user of the generative AI system 106 may enter a prompt 203 and any relevant contextual data, which may include a global context (enterprise strategy), business theme (specific function), and/or a task-specific layer (clear objectives). The user may also provide (e.g., upload) the converted data 128 (e.g., received from the data processing system) to the generative AI system 106. In general, a prompt 203 may refer to a few sentences or a block of text that provides instructions, context, or data to the generative AI system 106 to guide the output of the generative AI system 106. The prompt 203 may be in the form of targeted input, with a mix of natural language instructions and possibly some sample data (e.g., the converted data 128) to direct the response of the machine learning models at the generative AI system 106.

For example, the prompt 203 may include “(global context) as part of our enterprise-wide **digital transformation strategy**, we aim to enhance customer satisfaction by leveraging AI-driven analytics and automation; (business theme) the *Customer Experience (CX) team** needs insights into **service inefficiencies** and opportunities to enhance customer interactions using AI, (task-specific layer) analyze historical **customer service data** (chat logs, call transcripts, and survey responses). —Identify common pain points and service delays. —Suggest **AI-driven automation strategies** (e.g., chatbots, self-service tools). —Provide **quantifiable impact predictions** (e.g., reduced call handling time, increased CSAT). —Output response in *executive summary format (bullet points, charts, and key recommendations)**. In this way, the prompt 203 may also include the requested data based on the converted data 128.

For example, the converted data 128 may include normalized and/or categorized documents, such as sections from strategy reports, financial summaries, project descriptions, operational logs, customer feedback, etc. The prompt 203 may include contextual information or metadata describing a business sector (e.g., finance, operations, engineering, etc.), organizational priorities, applicable regulations, or market conditions relevant to the analysis, references to previously identified strategic objectives that may guide the generative AI system 106, explicit instructional language that may define a task (e.g., summarizing data, identifying relationships, requesting certain output data, classifying documents, etc.), etc.

The generative AI application 164 executing at the generative AI system 106 may receive the prompt 203, converted data 128, other contextual data, and the requested data as input data. The generative AI application 164 may apply the machine learning algorithms to the prompt 203, converted data 128, and other contextual data, and then generate predicted output data 209. The predicted output data 209 includes the requested data, which may include one or more of the strategic objective data 131, resource data 134, objective-to-resource mappings 145, resource parameter data 151, trend data 148, and/or action data 157, each of which may be inherently determined using converted data 128 and contextual data (e.g., based on the patterns and trends learned by the machine learning model at the generative AI system 106).

At operation 210, the generative AI application 164 may aggregate a history of prompts 203 collected over an extended period of time (e.g., months, years, etc.) that have been received at the generative AI system 106 and the corresponding predicted output data 209 to obtain prompt data 137. Prompt feedback data 211 may also be received from the user, for example, and may indicate an accuracy or performance metric for each prompt, indicating whether the generative AI system 106 produced an accurate, relevant, and intended result. The prompt feedback data 211 may include data capturing evaluations of predicted output data 209 generated by a generative AI system 106 in response to specific prompts 203, including accuracy indicators, correctness ratings, or other performance metrics that reflect how well the predicted output data 209 satisfied the intended purpose of the prompt 203, enabling refinement of suggested future prompts 203 and system behavior.

The prompt feedback data 211 indicating an association between a prompt 203 and an accuracy and completeness of the corresponding predicted output data 209 may be included as part of the prompt data 137 obtained at the generative AI system 106. The generative AI system 106 may transmit the prompt data 137 including the prompt feedback data 211 to the data processing system 103.

At operation 213, the application 123 at the data processing system 103 may evaluate the prompt data 137 and the prompt feedback data 211 to determine the prompts 203 that produced the most accurate or optimal predicted output data 209 (e.g., the predicted output data 209 that best matched the requested data in the prompt 203). The application 123 may also determine the prompts 203 that produced the least accurate predicted output data 209 (e.g., the predicted output data 209 that least matched the requested data in the prompt 203). The application 123 may use this evaluation to suggest prompts 203 in the future based on the content of the converted data 128, the requested data provided by the user, and/or any contextual data provided by the user. For example, the suggested prompts 203 may primarily align with the prompts 203 that produced the most accurate or optimal predicted output data 209 (with the corresponding historical prompts 203 that was associated with similar converted data 128, the requested data provided by the user, and/or any contextual data provided by the user).

Turning now to FIG. 2B, shown is a diagram 225 illustrating the training of the predictive model system 109. As shown in FIG. 2B, the training data 139 and feedback data 255 may be provided as input into the predictive model system 109 to train the applications and machine learning models at the predictive model system 109. The training data 139 includes historical data 142 collected over an extended period of time by the data processing system 103. The historical data 142 includes historical raw data 221 (e.g., raw data 121 collected from data stores 115 over an extended period of time), historical converted data 228 (e.g., converted data 128 that has been preprocessed and collected over an extended period of time), historical strategic objective data 231 (e.g., strategic object data 131 collected as output from the statistical application 124 and/or a selected system 163 over an extended period of time), historical resource data 234 (e.g., resource data 134 collected as output from the statistical application 124 and/or a selected system 163 over an extended period of time), historical objective-to-resource mappings 245 (e.g., objective-to-resource mappings 145 collected as output from the statistical application 124 and/or a selected system 163 over an extended period of time), historical resource parameter data 251 (e.g., resource parameter data 151 collected as output from the statistical application 124 and/or a selected system 163 over an extended period of time), historical trend data 248 (e.g., trend data 148 collected as output from the statistical application 124 and/or a selected system 163 over an extended period of time), and/or historical action data 257 (e.g., action data 157 collected as output from the statistical application 124 and/or a selected system 163 over an extended period of time). This historical data 142 may included labelled data that essentially consists of historical examples where the input data and the correct output (or label) are already known (e.g., the input data being the historical converted data 228 and the correct output data being at least one of the historical strategical objective data 231, historical resource data 234, historical objective-to-resource mappings 245, historical resource parameter data 251, historical trend data 248, and/or historical action data 257). The predictive application 171 and machine learning model algorithms at the predictive model system 109 may use supervised learning techniques to process this historical data 142, for example, adjusting internal model parameters to minimize the different between the predictions and known labels to accurately generalize new, unseen data.

Feedback data 255 may also be used to further refine the training of the algorithms, weights, parameters, etc., at the predictive application 171 and/or machine learning models, algorithms, weights, parameters, etc., at the predictive model system 109. The feedback data 255 may indicate the accuracy of the predicted output data 209 output by the predicted model system 109 over time (e.g., retraining on new initiative data, and adjusting leverage vs. modification decisions). In this way, the feedback data 255 may only be obtained once the predictive model system 109 is deployed and starts making predictions based on live or newly collected data. As the predictive model system 109 generates predicted output data 209, users or downstream processes may provide the feedback data 249 on whether those outputs were correct, partially correct, or incorrect. By incorporating the feedback data 255, the predictive model system 109 may adapt to evolving enterprise behaviors, terminology, and patterns, allowing the predictive model system 109 to maintain accuracy over time as operations change or as new types of data emerge.

At operation 259, the predictive model system 109 may use the training data 139 and the feedback data 255 to train (and refine the training) the machine learning models used by the predictive application 171, to receive input data, and then to generate the predicted output data 209. Similar to the generative AI system 106, the predicted output data 209 may include strategic objective data 131, resource data 134, objective-to-resource mappings 145, resource parameter data 151, trend data 148, and/or action data 157. The different data items in the predicted output data 209 may be inherently determined using converted data 128 and contextual data provided as input data may be into the predictive model system 109. The input data may be exposed via a REST API. For example, a user may send a POST request with the input data including converted data 128, requested data, and/or contextual data (e.g., initiative details). The API may process text embeddings and structured data, and then use the predictive application 171 and machine learning models to return the predicted output data 209. For example, the input data may include {“IntiativeDescription”: “Automate customer support using AI and cloud-based NLP models”, “Cost”: 8, “Time”: 9, “BusinessValue”: 12, “PastSuccessRate”: 0.85, “ProjectComplexityScore”: 3, “AvgInitiativeDelay”: 1.2,} , and the corresponding predicted output data 209 may include {“Leverage Platforms”: [“AWS”, “Azure”, “Salesforce”], “Modification Platforms”: [“SAP”, “Oracle”]}.

In some cases, the predicted output data 209 may include the predicted computing resources (e.g., software platforms) that align with the strategic objectives based on the historical data 142, a leverage versus modification decision to determine whether each platform should be leveraged (e.g., used as-is) or modified (e.g., enhanced or customized). The predicted output data 209 may also include confidence scores that provide probability estimates for each data item in the predicted output data 209, allowing a ranking of the computing resource 116 choices.

Turning now to FIG. 2C, shown is a diagram 275 illustrating the programming of the rule-based system 112 using the system rules 162. In an embodiment, the system rules 162 may be predefined and stored at the data store 125 of the data processing system 103, as mentioned above. In an embodiment, the application 123 at the data processing system 103 may transmit the system rules 162 to the rule-based system 112. In another embodiment, an operator may directly program the rule-based system 112 with the system rules 162. The rule-based application 181 executing at the rule-based system 112 may program the local algorithms according to the system rules 162, such that the rule-based application 181 is programmed to generate predicted output data 209 based on input data (which may be the converted data 128 received from the application 123 after the optimal system selection process).

As described herein, the system rules 162 include a set of conditional-action logic that the rule-based application 181 evaluates to determine predicted output data 209. The system rules 162 may be coded into the rule-based system 112 using predefined syntax or rule languages that the rule-based application 181 evaluates can interpret, such as decision tables, scripts, or formal rule definition languages. The rule-based system 112 itself may not modify or generate these system rules 162 automatically; instead, the rule-based system 112 may load the system rules 162 into memory and apply the system rules 162 deterministically to incoming input data (including the converted data 128, requested data, and other contextual data). Each piece of input converted data 128 may be evaluated against the system rules 162, and the rule-based application 181 may output the predicted output data 209 accordingly.

As above, the predictive output data 209 may include strategic objective data 131, resource data 134, objective-to-resource mappings 145, resource parameter data 151, trend data 148, and/or action data 157. The different data items in the predicted output data 209 may be inherently determined using converted data 128 and contextual data (e.g., based on the patterns and trends learned by the machine learning models at predictive model system).

For example, an input into the rule-based system 112 may recite “Automate customer engagement using AI and cloud solutions” with cost=$8 M, past success rate=85%, platform reliability=96%. The system rule 162 may include logic that first assigns themes like AI and data science, cloud computing, ERP, CRM, and cybersecurity based on keywords in the initiative description. These themes then guide resource selection, where AI projects may different platforms depending on cost, reliability, past success rate, etc. After the platforms are chosen, the rule-based system 112 decides whether to leverage or modify them by considering factors like success rate, reliability, and project complexity, ensuring the best fit for the initiative. The predicted output data 209 may then be the themes: AI and data science, cloud computing→platforms x, y, and z→leverage x platform→modify y platform.

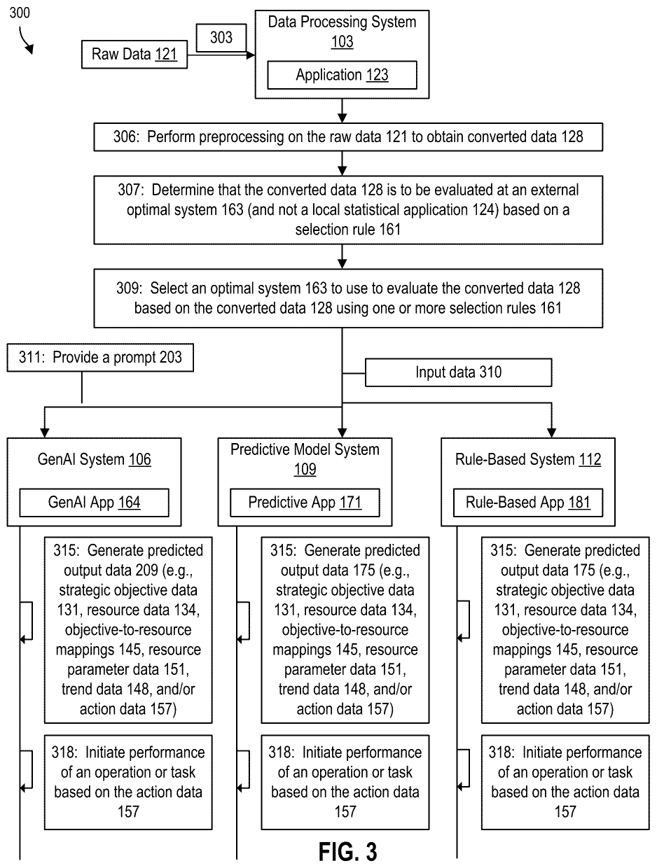

Referring now to FIG. 3, shown is a diagram illustrating a workflow the embodiments for multi-system selection for evaluating data to obtain strategic objective and resource correlations according to various embodiments of the disclosure. At operation 303, the application 123 executing at the data processing system 103 may receive relevant raw data 121 from one or more data stores 115. The relevant raw data 121 may be retrieved based on a request indicating, for example, a sector of the enterprise, a purpose of the data, historical strategic objectives, computing resources 116, etc.

At operation 306, the application 123 may perform preprocessing on the raw data 121 to obtain converted data 128. To preprocess the raw data 121 and obtain converted data 128, the application 123 may apply a normalization pipeline that converts heterogenous data formats of the raw data 121 into converted data 128 having unified, readable structures. The application 123 may perform deduplication and/or version control to eliminate redundant or outdated records (to ensure only that the most relevant and current data is processed) in the raw data 121. The application 123 may perform natural language processing (NLP) techniques to clean the text, standardize the terminology, and correct inconsistences in naming conventions across enterprise sectors in the raw data 121. The application 123 may apply entity extraction algorithms to identify key references to projects, departments, technologies, etc., while aligning events and records to support chronological correlation in the raw data 121. The application 123 may also perform categorization to assign documents or data entries in the raw data 121 to predefined categories (e.g., capital expenditures, service performance, infrastructure deployment, customer experience, etc.), allowing the application 123 to cluster related data efficiently. The converted data 128 may be categorized in the same manner as the corresponding raw data 121. The application 123 may perform one or more of the aforementioned preprocessing operations on the raw data 121 to obtain converted data 128, which may be used by a local statistical application 124 or an optimally selected system 163 to perform semantic alignment to link conceptually related converted data across different sectors.

At operation 307, the application 123 may determine, based on a selection rule 161, that the converted data 128 is to be evaluated at an external optimal system 163 (either the generative AI system 106, predictive model system 109, or the rule-based system 112)—rather than locally at the statistical application 124. For example, a selection rule 161 may indicate that the statistical application 124 is to be used to evaluate the converted data 128 when the application 123 receives data indicating that the converted data 128 is to be evaluated locally, with high-security, in a relatively efficient manner. In contrast, another selection rule 161 may indicate that an optimal system 163 external to the data processing system 103 is to be used to evaluate the converted data 128 when the application 123 receives data requested predicted output data 209 with high accuracy or eloquently worded content. In this case, the other selection rule 161 may be applicable, and consequently, the application 123 may proceed with operation 309.

At operation 309, the application 123 may select an optimal system 163 (from the generative AI system 106, the predictive model system 109, and the rule-based system 112) evaluate the converted data 128 based on the content and/or category of the converted data 128, any contextual data provided to the application 123 (e.g., organizational needs, applicable regulations, historical behaviors, business sectors, etc.). The application 123 may select the optimal system 163 using one or more selection rules 161, which as described above, may be based on the content and/or category of the converted data 128, any contextual data provided to the application 123, and the inherent strengths and weaknesses of the different systems 106, 109, and 112.

For example, the preprocessing step may have grouped certain items of the converted data 128 into one or more predefined categories. One or more selection rules 161 may indicate that data of a predefined category is to be instructed to be optimally provided to either the generative AI system 106, the predictive model system 109, or the rule-based system 112. The selection rules 161 may be based on predefined optimizations between types of input data (e.g., converted data 128) and the accuracy/reliability of the output data of the selected system 163. As described above, the selection rules 161 may also be based on the inherent characteristics or attributes of each of the generative AI system 106, the predictive model system 109, and the rule-based system 112. Therefore, the selection rules 161 may also consider organizational goals/needs, regulations, and other contextual factors that may affect whether the converted data 128 is to be input the into the generative AI system 106, predictive model system 109, or the rule-based system 112, based on the strengths and limitations of each.

In some cases, the selection rules 161 may also instruct different tasks or different types of data to be predicted across different ones of the systems 106, 112, and 109—to provide a synergistic effect between the different systems 106, 112, and 109. For example, when the user requests certain types of data in the form of eloquently written content, the generative AI system 106 may be selected, when the user requests other types of data to be determined based on historical patterns, the predictive model system 109 may be used, and when the user requests the most accurate output data, the rule-based system 112 may be selected. In this way, the different systems 106, 109, and 112 may be used separately in parallel for different data items in the converted data 128 based on the request.

Once the optimal system 163 is selected, the application 123 may provide input data 310 including the converted data 128 along with contextual data, requested data, and/or any other type of data to the selected system 163. If the selected system 163 is the generative AI system 106, the application 123 may also perform operation 311 to determine and provide a suggested prompt 203 (based on the prompt data 137 and the process described in FIG. 2A). Alternatively, a user may also manually input a prompt 203 into the generative AI system 106.

Regardless of whether the data is provided as input to the generative AI system 106, the predictive model system 109, and/or the rule-based system 112, all three systems 106, 109, 112 each use the input data 310 (either separately or in parallel) and the internal programming or training to perform operations 315 and 318. At operation 315, the selected system 163 (e.g., either the generative AI system 106, the predictive model system 109, or the rule-based system 112) may generate the predicted output data 209 (e.g., including the strategic objective data 131, resource data 134, objective-to-resource mappings 145, resource parameter data 151, trend data 148, and/or action data 157). For example, the generative AI application 164 may perform operation 315 using the trained machine learning models at the generative AI system 106; the predictive application 171 may perform operation 315 using the models/algorithms/weights/parameters/etc., trained using the training data 139 at the predictive model system 109; and the rule-based application 181 may perform operation 315 using the system rules 162 programmed at the rule-based system 112.

After performing operation 315 and obtaining the action data 157, the selected system 163 may perform operation 318. At operation 318, the selected system 163 may initiate performance of an operation or task based on the action data 157. As mentioned above, the operation may be determined primarily based on the strategic objective data 131, resource data 134, objective-to-resource mappings 145, and resource parameter data 151. When certain computing resources 116 exceed certain capacity thresholds (e.g., CPU utilization, memory consumption, storage usage, or network bandwidth), and depending on the strategic objectives being executed, the selected system 163 may trigger automated actions to maintain performance, ensure reliability, and align with the strategic objectives. For example, the operation may include modifying the use of computing resources 116 (e.g., automatically increasing or decreasing resource allocations to support strategic objectives like ensuring network reliability during high traffic periods or expanding compute for analytics workloads tied to customer experience improvements), load balancing (e.g., redistributing multiple computing resources 116 to prevent overload at a specific node or region, supporting objectives like minimizing service downtime or meeting SLAs tied to customer retention strategies), task prioritizing or throttling (e.g., adjusting task execution priorities to favor workloads aligned with higher-priority strategic objectives), resource reallocation (e.g., moving workloads, data processing jobs, or services from overloaded resources to underutilized resources to balance capacity and maintain service quality, which supports objectives such as optimizing operational efficiency), service degradation controls (e.g., proactively non-critical functionality or deferring non-essential tasks when capacity is low, helping sustain critical services that directly align with high-impact strategic objectives), and alerting/intervention triggers (e.g., generating notifications or automated incident reports to prompt manual intervention or initiate corrective workflows when resource capacity limits threaten strategic objective execution).

In some cases, the modification of use across the computing resources 116 may be based on the resource parameter data 151 indicating the use and capacity across the computing resources 116, in some cases, with particular regard to specific strategic objectives. For example, the selected system 163 may identify new strategic objectives that have not been identified in the past before (e.g., is not indicted in the historical strategic objective data 231). In this case, operation 318 may involve performing an operation directed to identifying and provisioning new computing resources 116 with specific technical capabilities that can most optimally make advancements toward the newly identified strategic objective. The newly identified computing resources 116 may be based on resource parameter data 151 indicating an available capacity at the newly identified computing resources 116, the capabilities at the newly identified computing resources 116, the historical behaviors at the newly identified computing resources 116, etc.

In some cases, certain strategic objectives may be more important than others or may have a more severe network/customer/security impact than others. In this case, these strategic objectives may be assigned weights based on the priority or importance of the strategic objectives, and the determined related to the higher priority strategic objectives may be performed before operations related to lower priority strategic objectives. This prioritization or weighting may figure into the allocation of resources and figure into the capital spending plans of the enterprise. The application 123 at the data processing system 103 may initiate performance or automate performance of the predicted operation across the computing resources 116 according to the priority order as instructed.

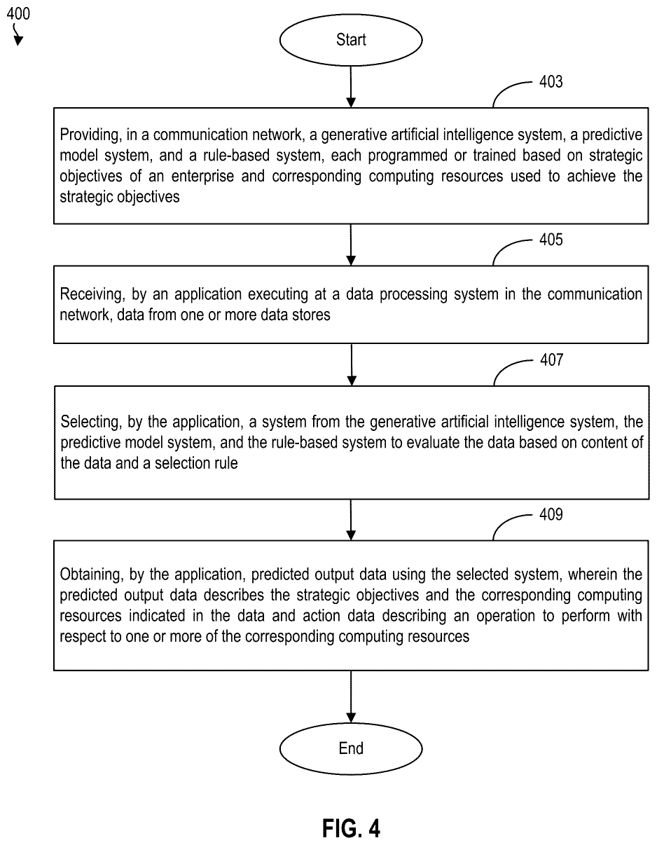

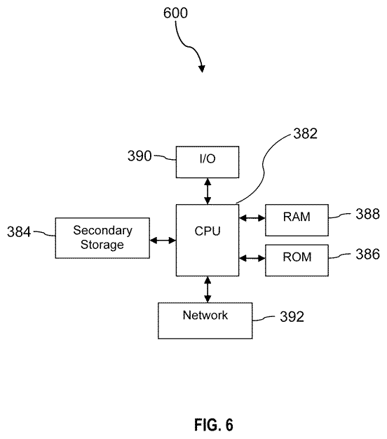

Referring now to FIG. 4, shown is a method 400 of multi-system selection and data evaluation for strategic objective and resource correlation according to an embodiment of the disclosure. Method 400 may be implemented by application 123 executing at the data processing system 103. In embodiments, the method 400 may be implemented using a computer system with components as shown in FIG. 6. As illustrated, method 400 of FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At step 403, method 400 comprises providing, in a communication network 100, a generative AI system 106, a predictive model system 109, and a rule-based system 112, each programmed or trained based on strategic objectives of an enterprise and corresponding computing resources 116 used to achieve the strategic objectives. At step 405, method 400 comprises receiving, by an application 123 executing at a data processing system 103 in the communication network 100, data (e.g., raw data 121) from one or more data stores 115. At step 407, method 400 comprises selecting, by the application 123, a system 163 from the generative AI system 106, the predictive model system 109, and the rule-based system 112 to evaluate the data based on content of the data and a selection rule 161. At step 409, method 400 comprises obtaining (e.g., determining or generating), by the application 123, predicted output data 209 using the selected system 163. In an embodiment, the predicted output data 209 describes the strategic objectives data and the corresponding computing resources 116 indicated in the resource parameter data 151 and action data 157 describing an operation to perform with respect to one or more of the corresponding computing resources 116.

Method 400 may include other steps and/or features that are not otherwise shown in FIG. 4. In an embodiment, method 400 may comprise generating, by the application 123, a prompt 203 that is suggested for the generative AI system 106 based on the data, in which the prompt 203 includes instructions and data that guide the generative AI system 106 to obtain the predicted output data 209. In an embodiment, the predictive model system 109 is trained using historical data 142 indicative of prior strategic objectives of the enterprise and prior corresponding computing resources 116 used to achieve the prior strategic objectives. In an embodiment, the rule-based system 112 is programmed with one or more system rules 161 indicating one or more conditions for correlating the strategic objectives with the corresponding computing resources.

In an embodiment, the predicted output data 209 comprises resource parameter data 151 describing a usage and capacity across the corresponding computing resources 116 with respect to each of the strategic objectives. In an embodiment, method 400 may further comprise instructing, by the application 123, to initiate performance of the operation at the one or more of the corresponding computing resources 116, in which the operation comprises increasing use of resources at the one or more corresponding computing resources 116 based on an available capacity at the one or more corresponding computing resources 116. In an embodiment, method 400 may further comprise instructing, by the application 123, to initiate performance of the operation at the one or more of the corresponding computing resources 116, in which the operation comprises stopping use of resources at the one or more corresponding computing resources 116 based on an expected use at the one or more corresponding computing resources 116 exceeding a predefined threshold.

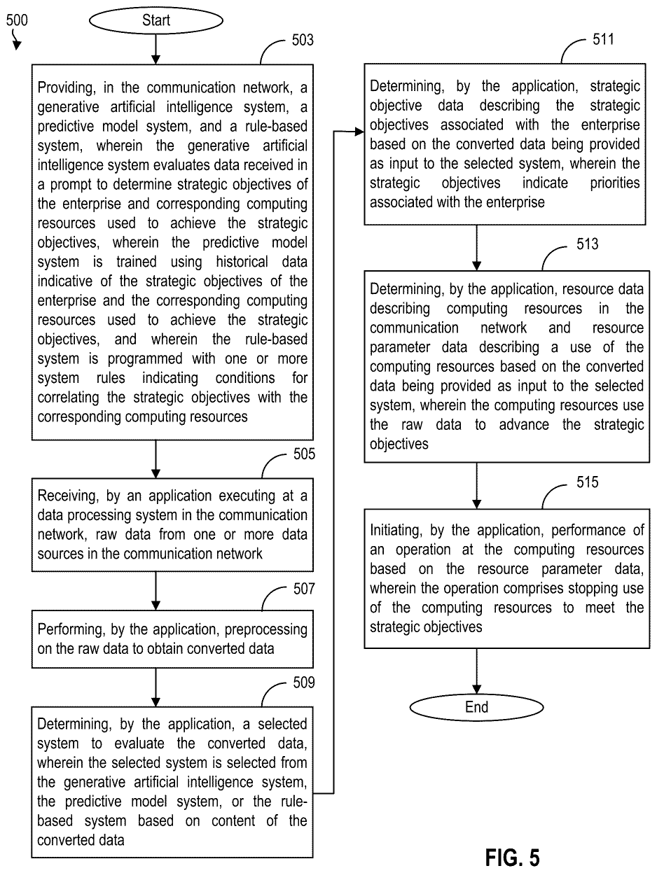

Referring now to FIG. 5, shown is a method 500 of multi-system selection and data evaluation for strategic objective and resource correlation according to an embodiment of the disclosure. Method 400 may be implemented by application 123 executing at the data processing system 103. In embodiments, the method 500 may be implemented using a computer system with components as shown in FIG. 6. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At step 503, method 500 comprises providing, in the communication network 100, a generative AI system 106, a predictive model system 109, and a rule-based system 112. The generative AI system 106 evaluates data received in a prompt 203 to determine strategic objectives of the enterprise and corresponding computing resources 116 used to achieve the strategic objectives, the predictive model system 109 is trained using historical data 142 indicative of the strategic objectives of the enterprise and the corresponding computing resources 116 used to achieve the strategic objectives, and the rule-based system 112 is programmed with one or more system rules 161 indicating conditions for correlating the strategic objectives with the corresponding computing resources. At step 505, method 500 comprises receiving, by an application 123 executing at a data processing system 103 in the communication network 100, raw data 121 from one or more data stores 115 in the communication network 100. At step 507, method 500 comprises performing, by the application 123, preprocessing on the raw data 121 to obtain converted data 128.

At step 509, method 500 comprises determining, by the application 123, a selected system 163 to evaluate the converted data 128, in which the selected system 163 is selected from the generative AI system 106, the predictive model system 109, or the rule-based system 112 based on content of the converted data 128. At step 511, method 500 comprises determining, by the application 123, strategic objective data 131 describing the strategic objectives associated with the enterprise based on the converted data 128 being provided as input to the selected system 163, in which the strategic objectives indicate priorities associated with the enterprise. At step 513, method 500 comprises determining, by the application 123, resource data 134 describing computing resources 116 in the communication network 100 and resource parameter data 151 describing a use of the computing resources 116 based on the converted data 128 being provided as input to the selected system 163. The computing resources 116 use the raw data 121 to advance the strategic objectives. At step 515, method 500 comprises initiating, by the application 123, performance of an operation at the computing resources 116 based on the resource parameter data 151, in which the operation comprises stopping use of the computing resources 116 to meet the strategic objectives.

Method 500 may include other steps and/or features that are not otherwise shown in FIG. 5. In an embodiment, the raw data 121 comprises at least one of financial documents, press releases, prior operation history, internal strategy document, proposal documents, spending records, proposal documents, customer support logs, internal memos, service outage reports, partnership announcements, regulatory filings, social media activity, or analyst reports. In an embodiment, performing, by the application 123, preprocessing on the raw data 121 to obtain the converted data 128 comprises performing at least one of deduplication on the raw data 121 to obtain the converted data 128, normalization on the raw data 121 to obtain the converted data 128, or categorization of the raw data 121 into one or more predefined categories based on content of the raw data 121 to obtain the converted data 128 sorted according to the predefined categories. In an embodiment, determining, by the application 123, the selected system 163 to evaluate the converted data 128 is further based on at least one of organizational goals associated with the enterprise, regulations applicable to at least one of the enterprise or the converted data 128, or operational needs of the enterprise.

In an embodiment, method 500 may further comprise determining, by the application, action data 157 describing the operation to perform at the computing resources 116 based on the converted data 128 being provided as input to the selected system 163 prior to initiating performance of the operation at the computing resources 116. In an embodiment, the resource parameter data 151 indicates at least one of a use of different instances of computing resources 116 for different strategic objectives or a capacity at each of the computing resources 116. In an embodiment, the selected system 163 is the generative AI system 106, in which case the method 500 may further comprise receiving, by the application 123, a suggested prompt 203 to provide to the generative AI system 106 with the converted data 128.

FIG. 6 illustrates a computer system 600 suitable for implementing one or more embodiments disclosed herein. In an embodiment, the data processing system 103, generative AI system 106, predictive model system 109, rule-based system 112, data stores 115, and computing resources 116, etc., may each be implemented as the computer system 600. The computer system 600 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 600, at least one of the CPU 382, the RAM 388, and the ROM 386 are changed, transforming the computer system 600 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 600 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 600 to provide the functionality of a number of servers that is not directly bound to the number of computers in the computer system 600. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 600, at least portions of the contents of the computer program product to the secondary storage 384, to the ROM 386, to the RAM 388, and/or to other non-volatile memory and volatile memory of the computer system 600. The processor 382 may process the executable instructions and/or data structures in part by directly accessing the computer program product, for example by reading from a CD-ROM disk inserted into a disk drive peripheral of the computer system 600. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 600.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 600 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for multi-system selection for evaluating data at an enterprise using a communication network based on system parameters, wherein the method comprises:
providing, in the communication network, a generative artificial intelligence system, a predictive model system, and a rule-based system, wherein the generative artificial intelligence system evaluates data received in a prompt to determine strategic objectives of the enterprise and corresponding computing resources used to achieve the strategic objectives, wherein the predictive model system is trained using historical data indicative of the strategic objectives of the enterprise and the corresponding computing resources used to achieve the strategic objectives, and wherein the rule-based system is programmed with one or more system rules indicating conditions for correlating the strategic objectives with the corresponding computing resources;
receiving, by an application executing at a data processing system in the communication network, raw data from one or more data sources in the communication network;
performing, by the application, preprocessing on the raw data to obtain converted data;
determining, by the application, a selected system to evaluate the converted data, wherein the selected system is selected from the generative artificial intelligence system, the predictive model system, or the rule-based system based on content of the converted data;
determining, by the application, strategic objective data describing the strategic objectives associated with the enterprise based on the converted data being provided as input to the selected system, wherein the strategic objectives indicate priorities associated with the enterprise;
determining, by the application, resource data describing computing resources in the communication network and resource parameter data describing a use of the computing resources based on the converted data being provided as input to the selected system, wherein the computing resources use the raw data to advance the strategic objectives; and
initiating, by the application, performance of an operation at the computing resources based on the resource parameter data, wherein the operation comprises stopping use of the computing resources to meet the strategic objectives.

2. The method of claim 1, wherein the raw data comprises at least one of financial documents, press releases, prior operation history, internal strategy document, proposal documents, spending records, proposal documents, customer support logs, internal memos, service outage reports, partnership announcements, regulatory filings, social media activity, or analyst reports.

3. The method of claim 1, wherein performing, by the application, preprocessing on the raw data to obtain the converted data comprises performing at least one of deduplication on the raw data to obtain the converted data, normalization on the raw data to obtain the converted data, or categorization of the raw data into one or more predefined categories based on content of the raw data to obtain the converted data sorted according to the predefined categories.

4. The method of claim 1, wherein determining, by the application, the selected system to evaluate the converted data is further based on at least one of organizational goals associated with the enterprise, regulations applicable to at least one of the enterprise or the converted data, or operational needs of the enterprise.

5. The method of claim 1, further comprising determining, by the application, action data describing the operation to perform at the computing resources based on the converted data being provided as input to the selected system prior to initiating performance of the operation at the computing resources.

6. The method of claim 1, wherein the resource parameter data indicates at least one of a use of different instances of computing resources for different strategic objectives or a capacity at each of the computing resources.

7. The method of claim 1, wherein the selected system is the generative artificial intelligence system, the method further comprises receiving, by the application, a suggested prompt to provide to the generative artificial intelligence system with the converted data.

8. A data processing system, comprising:
a non-transitory memory;
a processor communicatively coupled to the memory; and
an application stored at the memory, which when executed by the processor, causes the processor to be configured to:
receive raw data from one or more data sources in a communication network;
preprocessing the raw data to obtain converted data;
select a system from a generative artificial intelligence system, a predictive model system, and a rule-based system to evaluate the raw data, wherein the generative artificial intelligence system evaluates data received in a prompt to determine strategic objectives of an enterprise and corresponding computing resources used to achieve the strategic objectives, wherein the predictive model system is trained using historical data indicative of prior strategic objectives of the enterprise and prior corresponding computing resources used to achieve the strategic objectives, and wherein the rule-based system is programmed with one or more system rules indicating conditions for correlating the strategic objectives with the corresponding computing resources;
determine the strategic objectives of the enterprise and the corresponding computing resources used to achieve the strategic objectives based on the converted data being provided as input to the system, wherein the strategic objectives are priorities associated with the enterprise and the corresponding computing resources support advancement of the strategic objectives; and
initiate performance of an operation at one of the corresponding computing resources based on resource parameter data describing a use of the one of the corresponding computing resources.

9. The data processing system of claim 8, wherein the raw data comprises at least one of financial documents, press releases, prior operation history, internal strategy document, proposal documents, spending records, proposal documents, customer support logs, internal memos, service outage reports, partnership announcements, regulatory filings, social media activity, or analyst reports.

10. The data processing system of claim 8, wherein the preprocessing comprises performing deduplication on the raw data to obtain the converted data, normalization on the raw data to obtain the converted data, or categorization of the raw data into one or more predefined categories based on content of the raw data to obtain the converted data sorted according to the predefined categories.

11. The data processing system of claim 8, wherein the application is further configured to:
determine action data describing the operation to perform at the one of the corresponding computing resources based on the converted data being provided as input to the system; and
determine the resource parameter data based on the converted data being provided as input to the system.

12. The data processing system of claim 8, wherein the strategic objectives comprise at least one of improving network performance at the communication network, expanding service offerings to users, or improving infrastructure security at the communication network.

13. The data processing system of claim 8, wherein the corresponding computing resources comprise information technology (IT) computing resources that are used by the enterprise to carry out the strategic objectives.

14. A method comprising:
providing, in a communication network, a generative artificial intelligence system, a predictive model system, and a rule-based system, each programmed or trained based on strategic objectives of an enterprise and corresponding computing resources used to achieve the strategic objectives;
receiving, by an application executing at a data processing system in the communication network, data from one or more data stores;
selecting, by the application, a system from the generative artificial intelligence system, the predictive model system, and the rule-based system to evaluate the data based on content of the data and a selection rule; and
obtaining, by the application, predicted output data using the selected system, wherein the predicted output data describes the strategic objectives and the corresponding computing resources indicated in the data and action data describing an operation to perform with respect to one or more of the corresponding computing resources.

15. The method of claim 14, further comprising generating, by the application, a prompt that is suggested for the generative artificial intelligence system based on the data, wherein the prompt includes instructions and data that guide the generative artificial intelligence system to obtain the predicted output data.

16. The method of claim 14, wherein the predictive model system is trained using historical data indicative of prior strategic objectives of the enterprise and prior corresponding computing resources used to achieve the prior strategic objectives.

17. The method of claim 14, wherein the rule-based system is programmed with one or more system rules indicating one or more conditions for correlating the strategic objectives with the corresponding computing resources.

18. The method of claim 14, wherein the predicted output data comprises resource parameter data describing usage and capacity across the corresponding computing resources with respect to each of the strategic objectives.

19. The method of claim 14, further comprising instructing, by the application, to initiate performance of the operation at the one or more of the corresponding computing resources, wherein the operation comprises increasing use of resources at the one or more corresponding computing resources based on an available capacity at the one or more corresponding computing resources.

20. The method of claim 14, further comprising instructing, by the application, to initiate performance of the operation at the one or more of the corresponding computing resources, wherein the operation comprises stopping use of resources at the one or more corresponding computing resources based on an expected use at the one or more corresponding computing resources exceeding a predefined threshold.
